(19) United States
(12) Patent Application Publication
(10) Pub. No.: US 2026/0309397 A1
(43) Pub. Date: Oct. 8, 2026

(54) CRYOGENIC AUGER ASSEMBLY

(71) Applicant: Cryogenic Processors, LLC, Oklahoma City, OK (US)

(72) Inventor: Kevin McClain, Benton, KY (US)

(21) Appl. No.: 19/476,983

(22) PCT Filed: Apr. 17, 2024
(86) PCT No.: PCT/US2024/025045

§ 371 Date: Oct. 20, 2025

Related U.S. Application Data
(60) Provisional application No. 63/460,092, filed on Apr. 18, 2023.

(51) Int. Cl. F25D 3/11; B65G 33/10

(52) U.S. Cl. CPC F25D 3/11; B65G 33/10

(57) ABSTRACT

A cryogenic freezing system and process which utilizes an open conduit for its auger assembly. The open conduit allows fluids within the conduit to pass out of the channel and can allow particulate products in the freeze chamber to pass into the channel.

### CROSS REFERENCE TO RELATED APPLICATIONS

The present application claims priority to U.S. Provisional Application No. 63/460,092 filed on Apr. 18, 2023, which is incorporated herein.

### FIELD OF THE INVENTION

The present disclosure relates generally to cryogenic applications of auger assemblies, and more specifically, to auger assemblies that can be used for cryogenic applications involving frozen particles.

### BACKGROUND OF THE INVENTION

Freeze chambers have been used for freezing food products, among other things. In one freeze chamber system, a liquid substance is dripped into a freeze chamber. The falling droplets of liquid composition freeze rapidly in the freeze chamber, forming solid beads of product. The frozen beads are removed from the freeze chamber and packed for distribution and later consumption.

In some applications of such a freeze chamber, an auger-type apparatus has been used to remove the frozen beads from the freeze chamber. Unfortunately, along with the product, prior auger-type apparatuses have trapped and carried unwanted compounds, which can create safety issues. Accordingly, a need is identified to create a way to eliminate these safety issues.

### SUMMARY OF THE INVENTION

This disclosure primarily concerns an improved auger for use in freeze chambers and the removal of frozen products from freeze chambers. In accordance with embodiments, there is provided a cryogenic freezing system comprising a freeze chamber and auger system.

The freeze chamber contains a refrigerant, wherein the freeze chamber has a lower portion where particulate product can accumulate and an upper portion where a substance can be introduced. Optionally, there is a mechanism configured to introduce the substance into the upper portion of the freeze chamber so as to be frozen by the refrigerant into the particulate product as the substance passes downward in the freeze chamber.

The auger assembly comprises a conduit, a screw-type conveyor, and an outlet. The conduit is positioned in the freeze chamber so as to have an intake end in the lower portion, and an outlet end located outside the upper portion. The conduit forms an open channel which extends at least partially along a length of the conduit within the freeze chamber. The screw-type conveyor is disposed within the conduit. The outlet is located at the outlet end. Typically, the open channel is configured to allow fluids to escape from the conduit within the freeze chamber.

In accordance with embodiments, there is provided a process comprising:
introducing a substance into an upper portion of a freeze chamber;
introducing a refrigerant into the freeze chamber;
allowing the substance to pass from the upper portion to a lower portion of the freeze chamber such that the substance is frozen by the refrigerant into the particulate product as the substance passes downward in the freeze chamber;
introducing the particulate product at a lower portion of the freeze chamber into a conduit positioned in the freeze chamber wherein the conduit forms an open channel so as to allow fluids within the conduit to pass out of the channel and allow particulate product in the freeze chamber to pass into the channel;
moving the particulate product upward in the conduit toward an outlet located outside the freeze chamber which extends at least partially along a length of the conduit within the freeze chamber; and
removing the particulate product from the conduit through the outlet.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a schematic representation of a freeze chamber and auger system in accordance with this disclosure.

FIG. 2 is a schematic illustration of a side view of the auger system in the lower portion of the freeze chamber.

FIG. 3 is a schematic illustration of a front view of the auger system in the lower portion of the freeze chamber.

FIG. 4 is a schematic illustration of a top view of the auger system in the lower portion of the freeze chamber.

### DESCRIPTION OF EXEMPLARY EMBODIMENTS

The present disclosure may be understood more readily by reference to this detailed description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures, and components have not been described in detail so as not to obscure the related relevant feature being described. Also, the description is not to be considered as limiting the scope of the embodiments described herein.

This disclosure concerns, among other things, an improved auger for use in freeze chambers and the removal of frozen products therefrom.

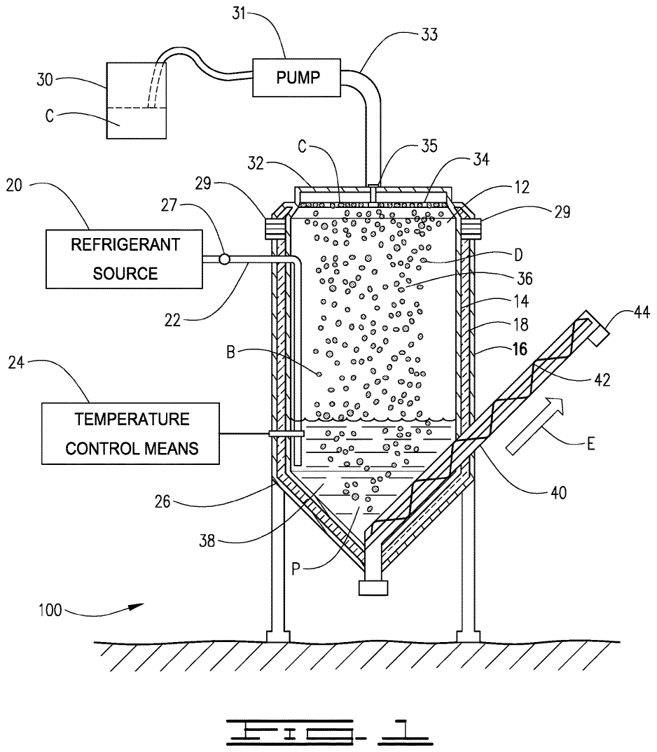

FIG. 1 shows a freeze chamber system 100, which may employ the improved auger system. Freeze chamber system 100 is configured to produce a free-flowing, frozen product consisting of frozen pellets or beads, which may for example be a food product. The free-flowing characteristics of the frozen product means that the pellets move in a continuous steady steam when poured from a container without clumping together or agglomeration of the pellets into larger particles. Thus, the beads remain as individual beads during production, shipping, storage and use—as long as they are kept at the appropriate temperature as discussed below—and no large ice crystal are formed during the production, shipping, or storage. While not wishing to be bound by theory, it is presently believed that the free-flowing characteristic is at least partially contributed to the beads having a dry outer surface. It should be recognized that this apparatus 100 is merely being described as an example of one type of apparatus designed for this purpose. Other designs may, of course, be utilized.

To obtain the free-flowing property, a liquid, paste or solid substance is dropped into a freeze zone in a droplet or pellet form (hereinafter referred to as (particulates”). The falling particulates are frozen rapidly to sub-zero temperatures by contact with a refrigerant. Generally, the freezing is carried out at temperatures of about −184° C. (about −300° F.) or less. Typically, liquid nitrogen is used as the refrigerant; thus, the freezing is carried out at liquid nitrogen temperatures, generally approximately at food grade (99.998% purity). Such temperatures are sufficient to achieve a free-flowing property. Subsequently, the product should be maintained at subzero temperatures to retain the free-flowing property. Typically, this will mean maintaining the product at temperatures of about −12° C. or less, and more typically −18° C. or less. Additionally, it presently is considered advantageous that the product remains free flowing at temperatures that are greater than −30° C. Typically, the frozen product remains solid and free flowing at temperatures from below −40° C. to about −12° C. It is especially advantageous if they are solid and free flowing from about −30° C. to about −12° C. The particulates and resultant final products will generally have a diameter from about 1 mm to about 15 mm.

The free-flowing characteristic of the frozen products makes them readily adaptable to machine type packing operations such as might be used on a production line in the packing of large quantities of product. The free-flowing characteristic makes the frozen product pourable allowing for the rapid, efficient packing of containers by hand or machine. Additionally, the free-flowing characteristic allows for the use of a wide variety of packaging or container types and shapes, for example cartons (both boxes and pourable cartons such as cardboard milk-carton types), bags, jars and bottles. Also, the frozen beads are suitable for heat sealed plastic and to foils, tubs, tubes and similar packaging.

Returning now to FIG. 1, freeze chamber system 100 includes a freeze chamber 12 having an inner wall 14 and outer wall 16. Preferably, both the walls are constructed of stainless steel to provide both strength and corrosion resistance. A thick layer of thermal insulating material 18 is provided between the walls to improve the efficiency of the freeze chamber by reducing the thermal transfer through the walls 14, 16 between the interior of the chamber 12 and the ambient environment.

The chamber 12 is chilled by the direct addition of refrigerant from a refrigerant source 20 through the delivery line 22. A number of different refrigerants can be utilized although liquid nitrogen is preferred. This material is readily available, relatively inexpensive and relatively inert to food products. It is also sufficiently cold to provide for relatively rapid freezing of the product. As such, it is particularly adapted for utilization in the processing of free-flowing, alimentary products.

The temperature of the freeze chamber 12 as well as the level of liquid refrigerant can be maintained within a specified range through the utilization of a temperature control means 24 such as a thermostat. More specifically, the temperature control means 24 may be connected to a thermocouple 26. The thermocouple 26 is positioned to extend into the freeze chamber 12 at a selected height between, for example, 4 to 18 inches above the bottom of the chamber to sense the temperature within the chamber. Where, for example, liquid nitrogen (LN2) is utilized as the refrigerant, the thermostat is set to maintain the temperature within the chamber 12 at the thermocouple 26 between approximately −184° C. (−300° F.) to −196° C. (−320° F.). The positioning of the thermocouple 26 some 4 to 18 inches above the bottom of the chamber 12 provides the necessary reservoir of refrigerant to quick freeze the droplets of the alimentary composition. The ultra-low temperature of the refrigerant limits the formation of ice crystals in the particulates as they are frozen.

When the temperature within the chamber 12 at the thermocouple 26 rises above the set range of operation, a valve 27 is then opened to allow delivery of liquid nitrogen from the source 20 through the line 22 to the chamber 12. Once the liquid refrigerant level within the chamber 12 reaches and contacts the thermocouple 26, the desired level of liquid refrigerant for freezing the composition is restored and the valve 27 is closed.

Vents 29 are provided in the walls 14, 16 near the top of the freeze chamber 12. These vents 29 serve to release rising nitrogen vapor from the chamber 12 and prevent any build-up in pressure in the chamber or any excess lowering of temperature near the top such that the dropper system is frozen over time. This exhaust can be controlled manually by venting through an exit pipe which is controlled by a damper. Alternatively, the exhaust gas can be collected under vacuum by the use of an exhaust fan. This cold vapor can be routed to other parts of the process where cold vapors can be utilized such as in storage spaces or with packaging machines.

The substance that is to be frozen is introduced into the upper portion 36 of freeze chamber 12. Upper portion 36 is above the liquid nitrogen, though upward moving nitrogen vapors will typically move through upper portion 36 and start the freezing of the particulates as they pass downward to lower portion 38 where they can accumulate for removal. Lower portion 38 typically at least partially contains liquid nitrogen.

The substance introduced into upper portion 36 will be formed into a particulate form within the freeze chamber. The forming of particulates can be prior to or as the substance enters lower portion 38. Generally, the substance can be introduced as a solid, paste or liquid, or even a combination thereof. For example, the substance can be an oil-based food, which often will be a paste or liquid but can be a solid. Additionally, the substance can be one that is comprised of functional bacteria, such as contributing to food through their enzyme portfolio and/or the release of metabolites, which for example can produce vitamins or amino acids.

For example, a liquid substance can be formed into particulates as illustrated in FIG. 1. As shown in FIG. 1, the substance C may be pumped from a supply container 30 into a dropper system including a tray 32 positioned across the upper end of the freeze chamber 12. More specifically, the composition is pumped by pump 31 through the tube 33 so as to be delivered through an inlet 35 in the top of the tray that closes the tray to prevent any residual dirt or dust in the air from falling into the composition. The bottom of the tray 32 includes a series of apertures 34 through which the composition drips into the freeze chamber 12. Preferably, the apertures have a diameter so as to provide the desired size droplets of composition for freezing into beads. Of course, the size of the droplets and rate of flow will be determined not only by the size of the holes, but the thickness of the composition and in some cases the thickness of the tray.

As the droplets D of composition fall downwardly in the freeze chamber, they contact cold nitrogen gas rapidly vaporizing from the pool of liquid nitrogen P at the bottom of the chamber. As a result of the temperature within the range of −127° C. (about −260° F.) to −196° C. (about −320° F.)—typical for LN2, rapid freezing of the droplets of composition occurs. The small beads B that are produced contain only relatively small ice crystals, thereby preserving their flavor properties. Generally, the beads B have a smooth, spherical appearance. While described for a liquid substance, the system 100 is readily adaptable to produce pellets of paste or solids for introduction into freeze chamber 12.

An auger assembly 40, for collecting the product, extends into the bottom of the chamber 12. Generally, the auger is positioned so that at least a lower part of the auger is in lower portion 38 of freeze chamber 12. As shown, the auger 40 is positioned at an angle of approximately 45 degrees with respect to the horizontal; though, the angle can typically be from about 20 degrees to about 70 degrees, and more typically from about 30 degrees to about 60 degrees. The auger 40 includes a screw-type conveyor 42. The conveyor 42 can have flights, which for example, can have a diameter of substantially 1.5″ to 3.5″. For example, the screw-type conveyor can be coupled to and extend around a rotatable axle within conduit 46 of auger assembly 40.

As the auger assembly 40 is rotated, the beads B are drawn upwardly in the direction of action arrow E by screw-type conveyor 42. Once the beads B reach the top of the auger 40, they exit auger 40 through an outlet 44 (illustrated as a chute) and can thereby be deposited in a container or onto a conveyer for further processing.

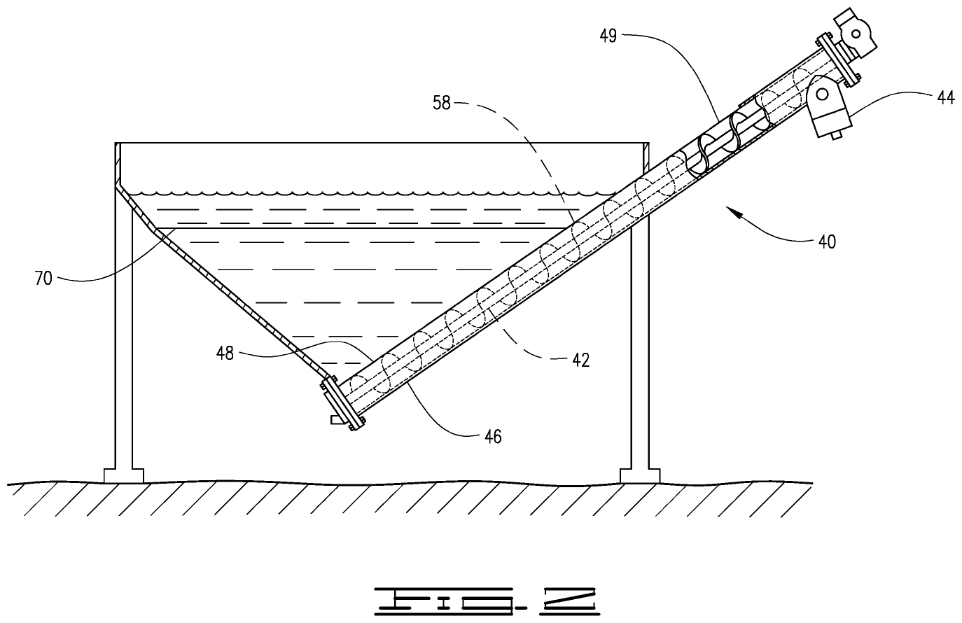

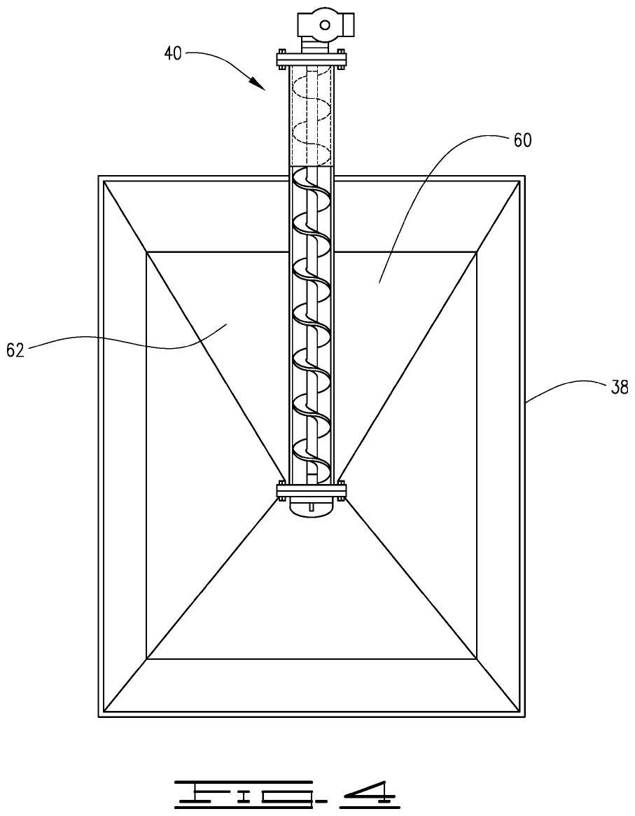

Turning now to FIGS. 2, 3 and 4, auger assembly 40 of this disclosure can be better seen. Auger assembly 40 has a conduit 46, which is positioned at least partially in freeze chamber 12. As illustrated, conduit 46 has an intake end 48 and an outlet end 49. Intake end 48 is in the lower portion 38 of freeze chamber 12, and typically is partially or entirely immersed in liquid refrigerant 70. Thus, generally 50% or more, 70% or more, 80% or more or 90% or more of intake end 48 is immersed in liquid refrigerant. Outlet end 49 generally extends outside of freeze chamber 12 so as to facilitate the removal of product from chamber 12 and auger assembly 40 through outlet 44.

It has been discovered that augur systems using a closed conduit suffer from pressure buildup, mainly due to nitrogen and other natural gases transitioning from a liquid state to a gaseous state with the auger system. Additionally, closed auger systems can have issues with the buildup of oxygen and combustible products, such as oils from food products. Since oxygen becomes a liquid at a higher temperature than nitrogen, atmospheric oxygen in chamber 12 tends to become a liquid and can get carried along in the auger system. If trapped in the auger systems, the oxygen and combustible products can represent a safety hazard. Accordingly, the auger system of the current disclosure is designed to overcome these issues.

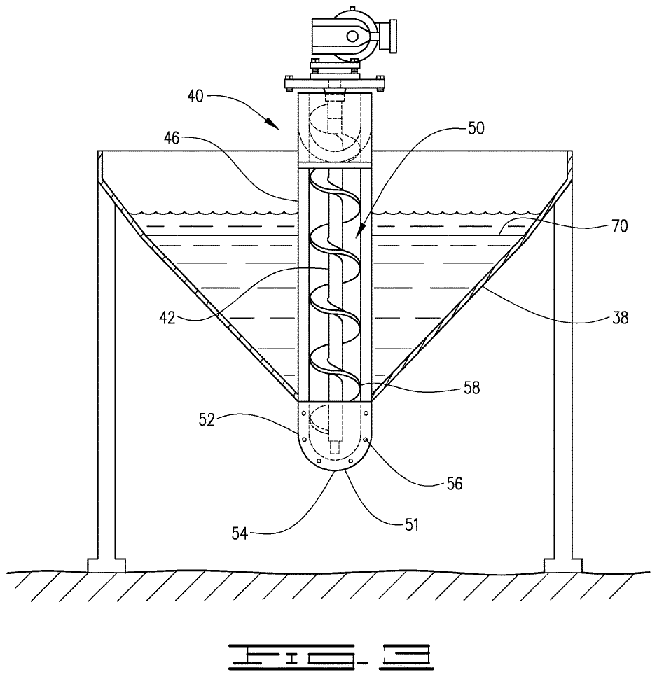

Conduit 46 of auger system 40 is designed to define an open channel 50 extending at least partially along intake end 48 such that it extends at least partially along a length of the conduit 46 within the freeze chamber 12. Open channel 50 forms a wall 51 extending from left side 52 to bottom side 54 to right side 56, but leaves top 58 of conduit 46 open to freeze chamber 12. Generally, open channel 50 is at least fifty percent of the length of the conduit within the freeze chamber 12, and optionally, at least seventy-five percent or at least ninety percent of the length of the conduit 46 within the freeze chamber 12. In embodiments, as illustrated in FIG. 3, open channel 50 extends to at least a portion of outlet end 49, and can extend substantially the entire length of conduit 46. The open channel 50 extending outside the freeze chamber 12 allows for venting of nitrogen and oxygen harmlessly to the surrounding atmosphere, thus aiding in avoiding pressure buildup and the buildup of oxygen with combustible oils. Additionally, it is within the scope of the invention for the open channel to extend substantially or entirely along the outlet end 49 with no open channel or only a partial open channel within the freeze chamber 12 (less than 20% or less than 10% of the length of the conduit 48 in freeze chamber 12). For example, the open channel 50 can extend at least 20%, at least 30%, at least 40%, at least 45% or at least 60% of the length of conduit 48. For example, the open channel 50 can extend up to 100%, up to 95%, up to 90%, up to 80%, up to 70%, up to 60%, or up to 50% of the length of conduit 48. For example, the open channel can extend from 20% to 95% of the length of conduit 48, or any less range included therein.

Typically, open channel 50 has a U-shaped cross-section, but even if not, open channel 50 is configured to receive screw-type conveyor 42, and is configured to allow fluids to escape from the conduit 46 within the freeze chamber 12 and/or outside of the freeze chamber 12. The fluids can include liquid or gaseous nitrogen and/or liquid or gaseous oxygen. Additionally, open channel 50 can allow frozen particulates of the product to enter auger system 40 along the length of open channel 50. In some embodiments, this entry is facilitated by freeze chamber 12 having one or more sides 60 and 62 that slope towards the conduit 46. Accordingly, the open channel 50 allows a greater area for entry of particulate products than past conveyors relying on an intake port.

The currently disclosed auger system can be used in a process wherein a substance is introduced into an upper portion of a freeze chamber, and a refrigerant is also introduced into the freeze chamber. The substance is allowed to pass from the upper portion to a lower portion of the freeze chamber such that the substance is frozen by the refrigerant into the particulate product as the substance passes downward in the freeze chamber. Subsequently, the particulate product is introduced at the lower portion of the freeze chamber into a conduit positioned in the freeze chamber, wherein the conduit forms the above described open channel so as to allow fluids within the conduit to pass out of the channel, and optionally, allow particulate product in the freeze chamber to pass into the channel. The particulate product in the auger is moved upward in the conduit towards the outlet located outside the freeze chamber. The particulate product is removed from the conduit through the outlet and can be packaged or further processed. Generally, the subzero temperature, described above, will be maintained during the packaging and/or further processing. Optionally, the packaged product can be shipped and/or stored while maintaining the subzero temperature.

The cryogenic freezing system and auger assembly of this disclosure can be further understood by reference to the following numbered embodiments.

Embodiment 1: A cryogenic freezing system comprising:
a freeze chamber containing a refrigerant, wherein the freeze chamber has a lower portion where particulate product can accumulate and an upper portion where a substance can be introduced;
a mechanism configured to introduce the substance into the upper portion of the freeze chamber so as to be frozen by the refrigerant into the particulate product as the substance passes downward in the freeze chamber; and
an auger assembly comprising:
   a conduit positioned in the freeze chamber so as to have an intake end in the lower portion and an outlet end located outside the upper portion, wherein the conduit forms an open channel that extends at least partially along a length of the conduit within the freeze chamber;
   a screw-type conveyor disposed within the conduit; and
   an outlet at the outlet end.

Embodiment 2: The cryogenic freezing system according to Embodiment 1, wherein the open channel is at least fifty percent of the length of the conduit within the freeze chamber.

Embodiment 3: The cryogenic freezing system according to Embodiment 1, wherein the open channel is at least seventy-five percent of the length of the conduit within the freeze chamber.

Embodiment 4: The cryogenic freezing system according to Embodiment, wherein the open channel is at least ninety percent of the length of the conduit within the freeze chamber.

Embodiment 5: The cryogenic freezing system according to any of Embodiments 1 to 4, wherein the open channel has a U-shaped cross-section.

Embodiment 6: The cryogenic freezing system according to any of Embodiments 1 to 5, wherein the open channel is configured to allow fluids to escape from the conduit within the freeze chamber.

Embodiment 7: The cryogenic freezing system according to any of Embodiments 1 to 6, wherein the freeze chamber has one or more sides that slope towards the conduit, and the open channel is configured to allow fluids to escape from the conduit within the freeze chamber and particulate product in the freeze chamber to enter the conduit.

Embodiment 8: The cryogenic freezing system according to any of Embodiments 1 to 7, wherein the open channel extends at least partially along a length of the conduit outside the freeze chamber.

Embodiment 9: A process comprising:
introducing a substance into an upper portion of a freeze chamber;
introducing a refrigerant into the freeze chamber;
allowing the substance to pass from the upper portion to a lower portion of the freeze chamber such that the substance is frozen by the refrigerant into the particulate product as the substance passes downward in the freeze chamber;
introducing the particulate product at a lower portion of the freeze chamber into a conduit positioned in the freeze chamber wherein the conduit forms an open channel so as to allow fluids within the conduit to pass out of the channel and allow particulate product in the freeze chamber to pass into the channel;
moving the particulate product upward in the conduit toward an outlet located outside the freeze chamber which extends at least partially along a length of the conduit within the freeze chamber; and
removing the particulate product from the conduit through the outlet.

Embodiment 10: The process according to Embodiment 9, wherein the open channel is at least fifty percent of the length of the conduit within the freeze chamber.

Embodiment 11: The process according to Embodiment 9, wherein the open channel is at least seventy-five percent of the length of the conduit within the freeze chamber.

Embodiment 12: The process according to Embodiment 9, wherein the open channel is at least ninety percent of the length of the conduit within the freeze chamber.

Embodiment 13: The process according to any of Embodiments 9 to 11, wherein the open channel has a U-shaped cross-section.

Embodiment 14: The process according to any of Embodiments 9 to 13, wherein the freeze chamber has one or more sides that slope towards the conduit so as to facilitate particulate product in the freeze chamber entering the conduit.

Embodiment 15: The process according to any of Embodiments 9 to 14, wherein nitrogen and oxygen vent out of the conduit and particulate product is carried up the conduit by the auger.

Embodiment 16: The process according to any of Embodiments 9 to 15, wherein the open channel extends at least partially along a length of the conduit outside the freeze chamber.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

Therefore, the present systems and methods are well adapted to attain the ends and advantages mentioned, as well as those inherent therein. Any examples disclosed above are illustrative only, as the present systems and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A cryogenic freezing system comprising:
a freeze chamber containing a refrigerant, wherein the freeze chamber has a lower portion where particulate product can accumulate and an upper portion where a substance can be introduced;
a mechanism configured to introduce the substance into the upper portion of the freeze chamber so as to be frozen by the refrigerant into the particulate product as the substance passes downward in the freeze chamber; and
an auger assembly comprising:
a conduit positioned in the freeze chamber so as to have an intake end in the lower portion and an outlet end located outside the upper portion, and wherein the conduit forms an open channel that extends at least partially along a length of the conduit within the freeze chamber;
a screw-type conveyor disposed within the conduit; and
an outlet at the outlet end.

2. The cryogenic freezing system according to claim 1, wherein the open channel is at least fifty percent of the length of the conduit within the freeze chamber.

3. The cryogenic freezing system according to claim 1, wherein the open channel is at least seventy-five percent of the length of the conduit within the freeze chamber.

4. The cryogenic freezing system according to claim 1, wherein the open channel is at least ninety percent of the length of the conduit within the freeze chamber.

5. The cryogenic freezing system according to claim 1, wherein the open channel has a U-shaped cross-section.

6. The cryogenic freezing system according to claim 1, wherein the open channel is configured to allow fluids to escape from the conduit within the freeze chamber.

7. The cryogenic freezing system according to claim 1, wherein the freeze chamber has one or more sides that slope towards the conduit, and the open channel is configured to allow fluids to escape from the conduit within the freeze chamber and particulate product in the freeze chamber to enter the conduit.

8. The cryogenic freezing system according to claim 7, wherein the open channel has a U-shaped cross-section and is at least fifty percent of the length of the conduit from within the freeze chamber.

9. The cryogenic freezing system according to claim 8, wherein the open channel extends at least partially along a length of the conduit outside the freeze chamber.

10. A process comprising:
introducing a substance into an upper portion of a freeze chamber;
introducing a refrigerant into the freeze chamber;
allowing the substance to pass from the upper portion to a lower portion of the freeze chamber such that the substance is frozen by the refrigerant into the particulate product as the substance passes downward in the freeze chamber;
introducing the particulate product at a lower portion of the freeze chamber into a conduit positioned in the freeze chamber wherein the conduit forms an open channel so as to allow fluids within the conduit to pass out of the channel and allow particulate product in the freeze chamber to pass into the channel;
moving the particulate product upward in the conduit toward an outlet located outside the freeze chamber which extends at least partially along a length of the conduit within the freeze chamber; and
removing the particulate product from the conduit through the outlet.

11. The process according to claim 10, wherein the open channel is at least fifty percent of the length of the conduit within the freeze chamber.

12. The process according to claim 10, wherein the open channel is at least seventy-five percent of the length of the conduit within the freeze chamber.

13. The process according to claim 10, wherein the open channel is at least ninety percent of the length of the conduit within the freeze chamber.

14. The process according to claim 10, wherein the open channel has a U-shaped cross-section.

15. The process according to claim 10, wherein nitrogen and oxygen vent out of the conduit and particulate product is carried up the conduit by the auger.

16. The process according to claim 10, wherein the freeze chamber has one or more sides that slope towards the conduit so as to facilitate particulate product in the freeze chamber entering the conduit.

17. The process according to claim 16, wherein the open channel has a U-shaped cross-section and is at least fifty percent of the length of the conduit within the freeze chamber.

18. The process according to claim 17, wherein nitrogen and oxygen vent out of the conduit and particulate product is carried up the conduit by the auger.

19. The process according to claim 18, wherein the open channel extends at least partially along a length of the conduit outside the freeze chamber.
